(19) United States
(12) Patent Application Publication
(10) Pub. No.: US 2010/0218376 A1
(43) Pub. Date: Sep. 2, 2010

(54) METHOD OF ASSEMBLING A DE-ICING MAT ON A PIECE OF WING STRUCTURE

(75) Inventor: Loic Boissy, Caudebec Les Elbeuf (FR)

Correspondence Address: HESPOS & PORCO LLP, 110 West 40th Street, Suite 2501, NEW YORK, NY, 10018, US

(73) Assignee: AERAZUR, Issy Les Moulineaux (FR)

(21) Appl. No.: 12/708,593

(22) Filed: Feb. 19, 2010

(30) Foreign Application Priority Data
Mar. 2, 2009 (FR) 09 51299

(51) Int. Cl. B23P 11/00

(52) U.S. Cl. 29/897.2; 244/134 A

(57) ABSTRACT

A method of assembling a de-icing mat (3) on a piece of wing structure (1) includes shaping a shielding foil (2) so that the internal surface (5) thereof has a shape that complements the external surface (6) of the piece of wing structure (1). The method then includes securing the de-icing mat (3) to the internal surface (5) of said shielding foil (2), leaving a surface uncovered with the de-icing mat on the contour (8) of the shielding foil (2) to allow direct contact between the contour (8) of the shielding foil (2) and the piece of wing structure (1) in a contact region (7) thus created. The method then includes attaching the shielding foil (2) to the piece of wing structure (1) at the contact region (7), and injecting a filling resin (4) between the de-icing mat (3) and the piece of wing structure (1).

### BACKGROUND OF THE INVENTION

1. Field of the Invention

The present invention relates to a method of assembling a de-icing mat on a piece of wing structure.

2. Description of the Related Art

It is known practice, in order to remove any ice that might form on a piece of wing structure, for said wing structure to be covered with a de-icing mat. Such a mat is generally bonded to the piece of wing structure. Advantageously, a shielding foil protects the piece of wing structure in a known way, covering the de-icing mat. This shielding foil is generally bonded to the de-icing mat. Such an assembly, which is satisfactory in terms of its mechanical integrity, is not, however, easy to dismantle. Dismantling may become necessary if the de-icing mat develops a fault and needs to be replaced. There is a risk that dismantling will cause the shielding foil and/or the piece of wing structure to become deformed. Debonding is usually done by using a solvent and/or high temperature heating. There is a risk that these two operations will damage the shielding foil and/or the piece of wing structure, particularly in the case of component parts made of composite. Following dismantling, it is sometimes impossible for the piece of wing structure and/or the shielding to be reused. This contributes toward making maintenance operations more complicated and toward increasing the cost thereof.

It is an object of the present invention to remedy these disadvantages by proposing a method of assembling a de-icing mat on a piece of wing structure that allows the de-icing mat to be removed with ease.

### SUMMARY OF THE INVENTION

The subject of the invention is a method of assembling a de-icing mat on a piece of wing structure, comprising the following steps:

shaping a shielding foil able to cover the piece of wing structure, such that the internal surface thereof has a shape that complements the external surface of said piece of wing structure facing it,

securing the de-icing mat to the internal surface of said shielding foil, leaving a surface uncovered with the de-icing mat on the contour of said shielding foil so as to allow direct contact between the contour of the shielding foil and the piece of wing structure in a contact region thus created,

attaching the shielding foil to said piece of wing structure at said contact region,

injecting a filling resin between the de-icing mat and the piece of wing structure.

According to another feature of the invention, the method further comprises, after the injection step, a step of curing the filling resin.

According to another feature of the invention, the method further comprises, before the attachment step, a step of fitting pads to the de-icing mat and/or to the piece of wing structure to ensure a minimum space between the de-icing mat and the piece of wing structure.

According to another feature of the invention, the method further comprises, before the attachment step, a step of depositing a release coat on the de-icing mat and/or on the piece of wing structure.

According to another feature of the invention, the method further comprises, before the attachment step, a step of fitting an insulating bladder on the de-icing mat facing the piece of wing structure and, before the injection step, a step of inflating said bladder.

According to another feature of the invention, the method further comprises, after the curing step, a step of deflating the insulating bladder.

According to another feature of the invention, the insulating bladder is positioned facing regions in which the de-icing mat is of the thermal type.

According to another feature of the invention, the method further comprises, before the attachment step, a step of fitting a seal in the contact region so that said seal is positioned between the piece of wing structure and the shielding foil.

According to another feature of the invention, the method further comprises, after the attachment step, a step of introducing a mastic into the contact region at the contour of the shielding foil.

According to another feature of the invention, the method further comprises, after the attachment step, a step of depositing a conducting varnish on the contour of the shielding foil.

The invention will now be described in greater detail with reference to some particular embodiments given solely by way of illustration and depicted in the attached figures.

### BRIEF DESCRIPTION OF THE DRAWINGS

FIGS. 1-4 depict successive steps in the method of assembly according to the invention, viewed in cross section.

FIG. 5 depicts a dismantling step.

### DETAILED DESCRIPTION OF THE PREFERRED EMBODIMENT

It goes without saying that the detailed description of the subject matter of the invention, provided solely by way of illustration, does not in any way limit the invention, technical equivalents also being included within the scope of the present invention.

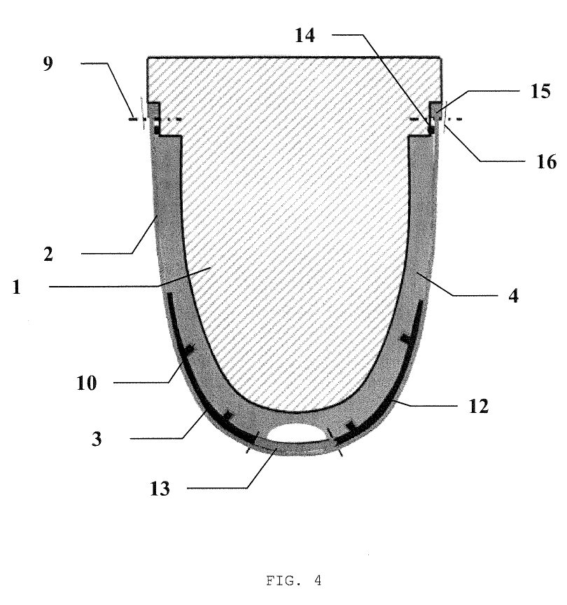

A finished assembly is illustrated in FIG. 4. It comprises a piece of wing structure 1 viewed in cross-section, a shielding foil 2 covering said piece of wing structure 1, trapping a de-icing mat 3 between the shielding foil 2 and the piece of wing structure 1.

A piece of wing structure generically denotes an airplane wing, a control surface, a propeller or fan blade, a helicopter rotor blade, or any other equivalent component.

A de-icing mat 3 is a flexible mat intended to de-ice the assembly. It therefore acts in such a way that the external surface of the assembly, namely the external surface of the shielding foil 2, becomes de-iced. There are two types of de-icing mat 3.

A first type, known as a thermal de-icing system, has a thermal mode of operation. Close contact between the de-icing mat 3 and the internal surface 5 of the shielding foil 2 allows heat produced by the thermal de-icing mat 13 to be transmitted to the shielding foil 2. Said heat is imparted to the external surface of the shielding foil 2 and thus causes any deposit of ice that might be present on this external surface to melt.

A second type, known as an electromechanical expulsion de-icing system, has a mechanical mode of operation. A shock is produced by the de-icing mat 3. Close contact between the de-icing mat 3 and the internal surface 5 of the shielding foil 2 allows said shock produced by the electromechanical expulsion de-icing mat 12 to be transmitted to the shielding foil 2. Said shock is transmitted as far as the external surface of the shielding foil 2 and thus causes any film of ice that may be present on this external surface to detach.

Whether it is a thermal mat 13 or an electro-mechanical expulsion de-icing mat 12 that proves the more effective depends on the regions of the piece of wing structure 1. Thus, for example, a thermal mat 13 is preferred for the leading edge of the piece of wing structure 1 where the curvature is great, whereas an electromechanical expulsion de-icing mat 12 is better suited to regions of lower curvature. The two types complement one another and a de-icing mat 3 is conventionally made up of a collection of regions of the thermal type 13 and of regions of the electro-mechanical expulsion de-icing type 12.

The method for creating such an assembly comprises a first step of shaping a shielding foil 2 so that it can cover the piece of wing structure 1. Thus, the internal surface 5 thereof has a shape that complements the external surface 6 of the piece of wing structure 1 facing it.

In a second step, a de-icing mat 3 is secured to the internal surface 5 of said shielding foil 2. This securing operation may be performed using bonding, which is performed by any known means, for example in the conventional way, using a primer and a contact adhesive.

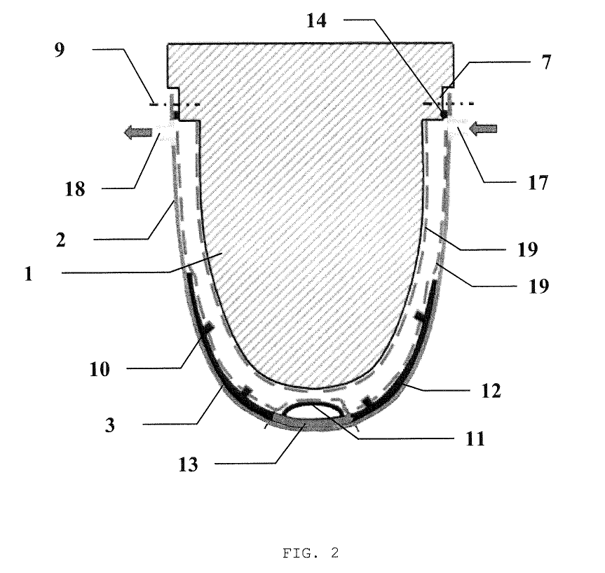

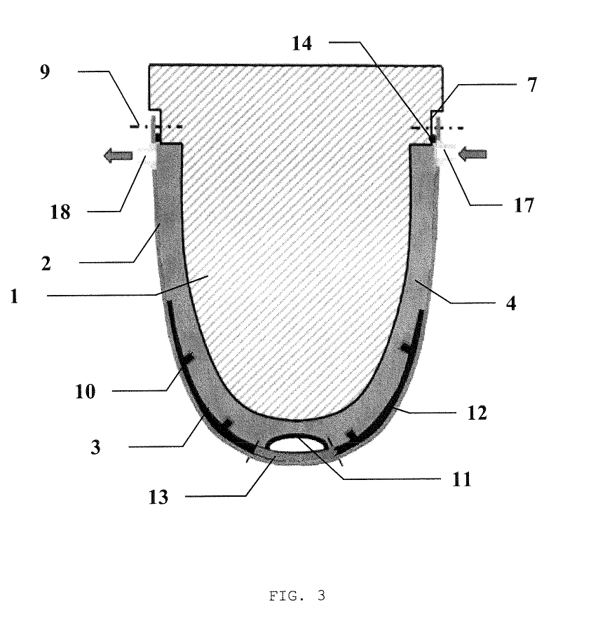

As may be seen in FIGS. 2, 3 and 4, this securing operation leaves an uncovered surface 7, with no de-icing mat, at least at the contour 8 of the shielding foil 2. This reserved area allows there to be direct contact between the contour 8 of the shielding foil 2 and the piece of wing structure 1 in a contact region 7 thus created.

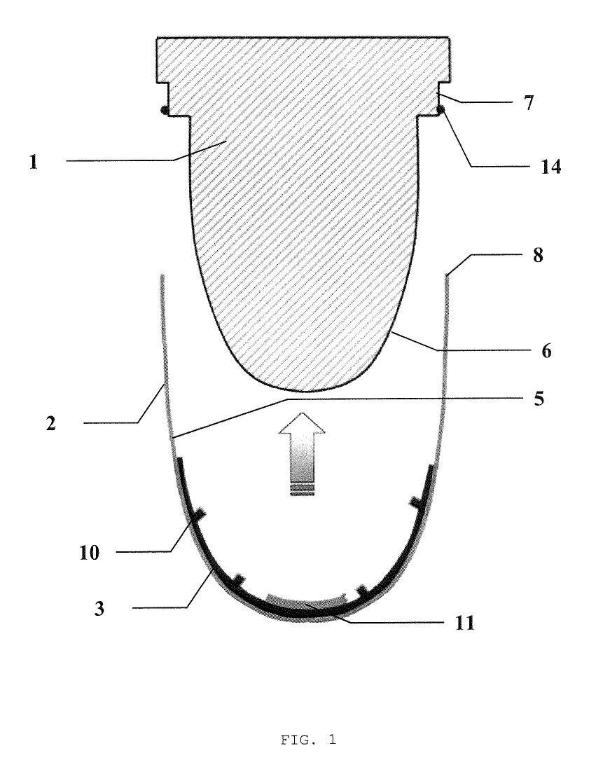

On completion of these two steps, the assembly is in the state illustrated in FIG. 1.

In a third step, illustrated in FIG. 2, the shielding foil 2 is brought into a position of contact with the piece of wing structure 1 and is attached to said piece of wing structure 1 at said contact region 7. This attachment may be achieved by any known means, such as bonding, riveting, screw fastening, here represented by fasteners 9 depicted as a single axis line.

Still with reference to FIG. 2, the assembly is then prepared for an injection step. For that, at least one injection opening 17 and at least one suction opening 18 are created.

The fourth step is to inject a filling resin 4 between the de-icing mat 3 and the piece of wing structure 1. The resin 4 is injected through said injection opening 17 while suction is applied to the suction opening 18. Thus, the resin 4 fills all of the interstitial space formed between the piece of wing structure 1 and the de-icing mat 3 or the shielding foil 2.

At the end of the step of injecting the resin 4, the injection 17 and suction 18 openings are eliminated.

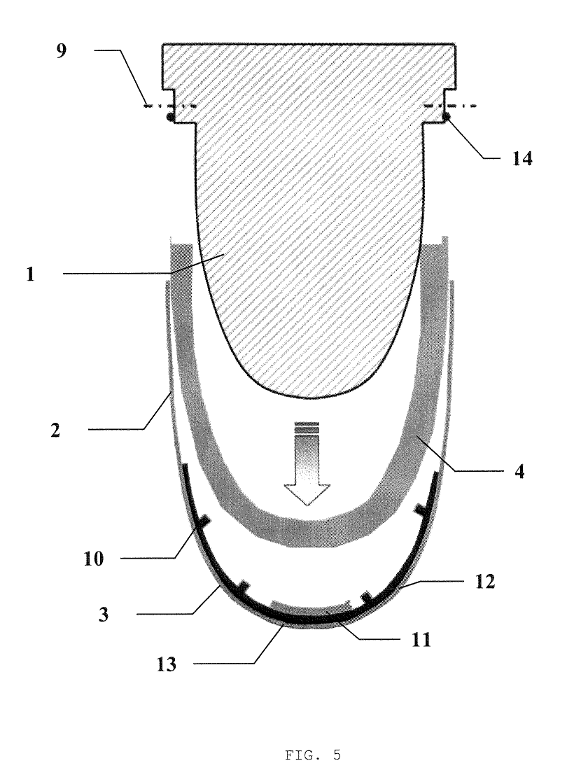

The main advantage of the invention can be seen here. The resin 4 has much weaker adhesion than adhesive bonding, both to the piece of wing structure 1 and to the de-icing mat or the shielding foil 2. A dismantling operation illustrated in FIG. 5 can easily be performed simply by removing the fasteners 9. It is then an easy matter to detach the shielding foil 2 equipped with the de-icing mat 3, the bit of resin 4 and the piece of wing structure 1, without the risk of any of the useful components 1, 2, 3 being deformed or damaged. The bit of resin 4, which is inexpensive, can be discarded.

It is then possible using known methods to detach the de-icing mat 3 or simply that part of the de-icing mat 3 that is faulty, so that it can be replaced.

Next, the assembly may be reassembled by applying the same steps as those described previously.

This method can advantageously be applied to a piece of wing structure 1 made of metal or composite. Likewise, the shielding foil 2 may be made of metal, plastic, or even a composite.

Depending on the type of resin, it is advantageous for the filling resin 4 to be cured after the injection step. This can be done, particularly in the case of thermosetting resins, by applying a heating blanket to the external surface of the shielding foil 2.

The filling resin 4 may be of any known type that can be cured. Advantageously, the resin 4 may be an epoxy resin. Advantageously, its characteristics are:

| Material | Epoxy |
|---|---|
| Hardness | >80 shore D |
| Continuous service | >120° C. |
| temperature once cured | |
| Curing temperature | 20° C. < Tr < 80° C. |
| Maximum molding thickness | 50 mm |
| Viscosity | 1 mPa · s < V < 20 000 mPa · s |
| Shrinkage | <0.1% |

Advantageously also, before the attachment step, pads 10 may be fitted between the de-icing mat 3 and the piece of wing structure 1. The purpose of these pads 10 is to maintain a minimum thickness to ensure that there is a space between the piece of wing structure 1 and the de-icing mat 3 or the shielding foil 2. This minimum space may have a constant thickness if pads 10 of constant height are used. By maintaining a certain thickness, these pads 10 play a part in making it easier for the resin 4 to flow at the time of injection. These pads 10 may be positioned on the de-icing mat 3 and/or on the piece of wing structure 1. Advantageously they may be formed as an integral part of the de-icing mat 3 and/or the piece of wing structure 1.

To make the assembly easier to dismantle and the component parts of the assembly easier to take apart, a step of depositing a release coat 19 on the de-icing mat 3, on the piece of wing structure 1, or alternatively on both, at the interface between the resin 4 and one of the components 1, 2, 3 is advantageously performed before the attachment step. One exemplary embodiment of such a release coat 19 is to deposit a resin mold-release product. This product can be applied using a spray gun.

In order to form a reserve by leaving an empty space behind part of the de-icing mat 3, a step of fitting an insulating bladder 11 may be advantageously performed before the attachment step. This insulating bladder 1 is placed on the de-icing mat 3, on the opposite face to the shielding foil 2, namely facing the piece of wing structure 1.

Before proceeding with the injection step, a step of inflating said insulating bladder 11 is performed. Thus, the inflated insulating bladder 11 reserves a volume at the back of the de-icing mat 3 which does not become occupied by the resin 4.

Once the resin 4 has set as a result of the curing step, it is possible to deflate the bladder 11. This deflation reduces said bladder 11, which may even be withdrawn, and creates an air gap at the back of the de-icing mat 3.

Such an air gap is particularly functional at the back of a de-icing mat 3 of the thermal type 13 because the heat loss of the thermal de-icing device 13 into the air of said gap is less than the heat loss that would occur into the resin 4.

By contrast, the resin 4 on the back of an electromechanical expulsion de-icing device 12 is of great benefit. By pressing the electromechanical expulsion de-icing device 12 against the shielding foil 2, the resin 4 contributes to improving the transmission of the shock to the shielding foil 2 and therefore contributes to the effectiveness of the de-icing.

Hence, advantageously, an insulating bladder 11 is positioned facing regions where the de-icing mat 3 is of the thermal type 13.

To improve the sealing of the connection between the piece of wing structure 1 and the shielding foil 2, the method advantageously comprises, before the attachment step, a step of fitting a seal 14 in the contact region 7. This seal 14 is positioned on the piece of wing structure 1 or on the shielding foil 2, so that when the shielding foil 2 is assembled on the piece of wing structure 1, said seal 14 becomes positioned between the piece of wing structure 1 and the shielding foil 2 in the contact region 7.

Advantageously also, in order to finish off the interface between the piece of wing structure 1 and the shielding foil 2, a mastic 15 may be introduced into the contact region 7 at the contour 8 of the shielding foil 2. Such a step is illustrated in FIG. 4.

As an alternative or in addition to the step of introducing mastic, a step of depositing a conducting varnish 16 on the contour 8 of the shielding foil 2 may be performed after the attachment step.

What is claimed is:

1. A Method of assembling a de-icing mat (3) on a piece of wing structure (1), characterized in that it comprises the following steps:
shaping a shielding foil (2) able to cover the piece of wing structure (1), such that the internal surface (5) thereof has a shape that complements the external surface (6) of said piece of wing structure (1) facing it,
securing the de-icing mat (3) to the internal surface (5) of said shielding foil (2), leaving a surface uncovered with the de-icing mat on the contour (8) of said shielding foil (2) so as to allow direct contact between the contour (8) of the shielding foil (2) and the piece of wing structure (1) in a contact region (7) thus created,
attaching the shielding foil (2) to said piece of wing structure (1) at said contact region (7),
injecting a filling resin (4) between the de-icing mat (3) and the piece of wing structure (1).

2. The method of claim 1, further comprising, after the injection step, a step of curing the filling resin (4).

3. The method of claim 2, further comprising, before the attachment step, a step of fitting pads (10) to the de-icing mat (3) or to the piece of wing structure (1) to ensure a minimum space between the de-icing mat (3) and the piece of wing structure (1).

4. The method of claim 2, further comprising, before the attachment step, a step of depositing a release coat (19) on the de-icing mat (3) or on the piece of wing structure (1).

5. The method of claim 2, further comprising, before the attachment step, a step of fitting an insulating bladder (11) on the de-icing mat (3) facing the piece of wing structure (1) and, before the injection step, a step of inflating said insulating bladder (11).

6. The method of claim 5, further comprising, after the curing step, a step of deflating the insulating bladder (11).

7. The method of claim 5, in which the insulating bladder (11) is positioned facing regions in which the de-icing mat (3) is of a thermal type (13).

8. The method of claim 1, further comprising, before the attachment step, a step of fitting a seal (14) in the contact region (7) so that said seal (14) is positioned between the piece of wing structure (1) and the shielding foil (2).

9. The method of claim 1, further comprising, after the attachment step, a step of introducing a mastic (15) into the contact region (7) at the contour of the shielding foil (2).

10. The method of claim 1, further comprising, after the attachment step, a step of depositing a conducting varnish (16) on the contour (8) of the shielding foil (2).
